(19) United States
(12) Patent Application Publication
(10) Pub. No.: US 2015/0166306 A1
(43) Pub. Date: Jun. 18, 2015

(54) ELEVATOR DOOR HAVING AN ATTACHED ROLLER ASSEMBLY

(71) Applicant: THYSSENKRUPP ELEVATOR AG, Essen (DE)

(72) Inventors: Maurizio Esposito, Boblingen (DE); Bernd Heim, Nufringen (DE); Adam Kolasinski, Dettingen unter Teck (DE)

(73) Assignee: THYSSENKRUPP ELEVATOR AG, Essen (DE)

(21) Appl. No.: 14/414,871

(22) PCT Filed: Jul. 16, 2013
(86) PCT No.: PCT/EP2013/065013

§ 371 Date: Jan. 14, 2015

(30) Foreign Application Priority Data
Jul. 16, 2012 (EP) 12176542.4

(51) Int. Cl. B66B 13/30; B66B 19/00; B66B 13/08

(52) U.S. Cl. CPC B66B 13/30; B66B 13/08; B66B 19/00

(57) ABSTRACT

The invention relates to a lift door having a bearing unit with a supporting unit and at least one running roller arrangement which is attached to the supporting unit and which has a running roller and a bearing axle, on which the running roller is rotatably mounted, and a door leaf attached to the bearing unit, wherein the bearing unit is designed to displaceably mount the lift door in a door transom, in that the running roller of the running roller arrangement can roll on a rail of the door transom, wherein the running roller arrangement is designed to be installed on the supporting unit and removed from the supporting unit as a unit.

### PRIOR ART

A lift door, i.e. a cab door or shaft door, commonly comprises a door leaf which is attached to a bearing unit (termed a suspension gear). The bearing unit generally has a supporting unit (termed a roller plate) with running rollers attached thereto which in turn roll on a rail of a door transom. The running rollers become worn over time and must be exchanged at intervals. To that end, the running roller to be exchanged must first be relieved of the weight of the lift door. Then, the axle on which the roller is rotatably mounted is released from the supporting unit and pushed through the roller towards the back (i.e. towards that side of the door oriented away from the installer). That being done, the roller can be removed and exchanged. This work is very onerous and, also, access is difficult on account of the position of the rollers above the lift door. Furthermore, sufficient space behind the supporting unit is required in order to be able to push the axle outwards towards the back. This disadvantageously increases the space requirement for the shaft and/or the doorsill.

It is therefore desirable to simplify the process of changing a running roller of a lift door.

### DISCLOSURE OF THE INVENTION

The invention proposes a lift door and a method for installing or removing a running roller arrangement with the features of the independent claims. Advantageous embodiments form the subject matter of the subclaims and of the following description.

### ADVANTAGES OF THE INVENTION

The invention proposes a lift door, i.e. a cab door or a shaft door, with a running roller arrangement which can be removed, in particular towards the side or the front. The running roller arrangement has a running roller which supports a weight of the lift door and a bearing axle. It is thus possible to simplify a running roller change, since it is in particular not necessary to separate the running roller and the bearing axle in the installed state, in particular above one's head. If the running roller arrangement can in addition be removed from the supporting unit towards the side or the front, the required free space behind the supporting unit is reduced. Towards the side means in a direction parallel to a principal plane of extent of the lift door, but not towards the front or the back. Towards the front means towards the installer, i.e. in a direction perpendicular to a principal plane of extent of the lift door.

By virtue of the possibility of removing the running roller arrangement as a unit, the supporting unit itself can then remain at the installation location. Settings and adjustments performed with respect to the supporting unit (clearances, orientations and the like) are advantageously retained.

Advantageously, the running roller arrangement comprises only few elements, in particular only the running roller and the bearing axle, alternatively also at least one retaining element, to which the bearing axle is attached. The retaining element advantageously serves to stabilize a connection between the bearing axle and the supporting unit. Also for stabilizing purposes, the retaining element can also perform other functions. For example, buffers or switches can be installed thereon. It can also serve as an emergency guide e.g. in the event of a running roller failure.

In particular, the running roller arrangement has only rollers which support a weight of the lift door, and has no further rollers which support no weight, such as counter rollers. Advantageously, the running roller arrangement has only a single roller, namely the running roller.

If the supporting unit has an axle opening which is designed to receive the bearing axle, the bearing axle can run through the supporting unit, so as to improve the transmission of forces.

Installing or removing the running roller arrangement can in particular be simplified if the supporting unit has at least one relief device which is designed to relieve the running roller arrangement. The relief device can in particular have a screw device by means of which the running roller can be lifted off the rail of the door transom if the bearing unit is on the door transom.

Further advantages and embodiments of the invention will emerge from the description and the appended drawing.

It is to be understood that the features mentioned above and those still to be explained below can be used not only in the combination indicated in each case, but also in other combinations or in isolation, without departing from the scope of the present invention.

The invention is represented schematically in the drawing with reference to an exemplary embodiment and will be described exhaustively below with reference to the drawing.

### DESCRIPTION OF THE FIGURES

FIG. 1 shows an embodiment of a lift door according to the invention, having two different running roller arrangements.

FIG. 2 shows an enlarged representation of a first of the two different running roller arrangements from FIG. 1.

FIG. 3 shows an enlarged representation of a second of the two different running roller arrangements from FIG. 1.

### DETAILED DESCRIPTION OF THE DRAWING

The invention will be coherently and comprehensively described below with reference to the figures, wherein identical elements are provided with identical reference signs.

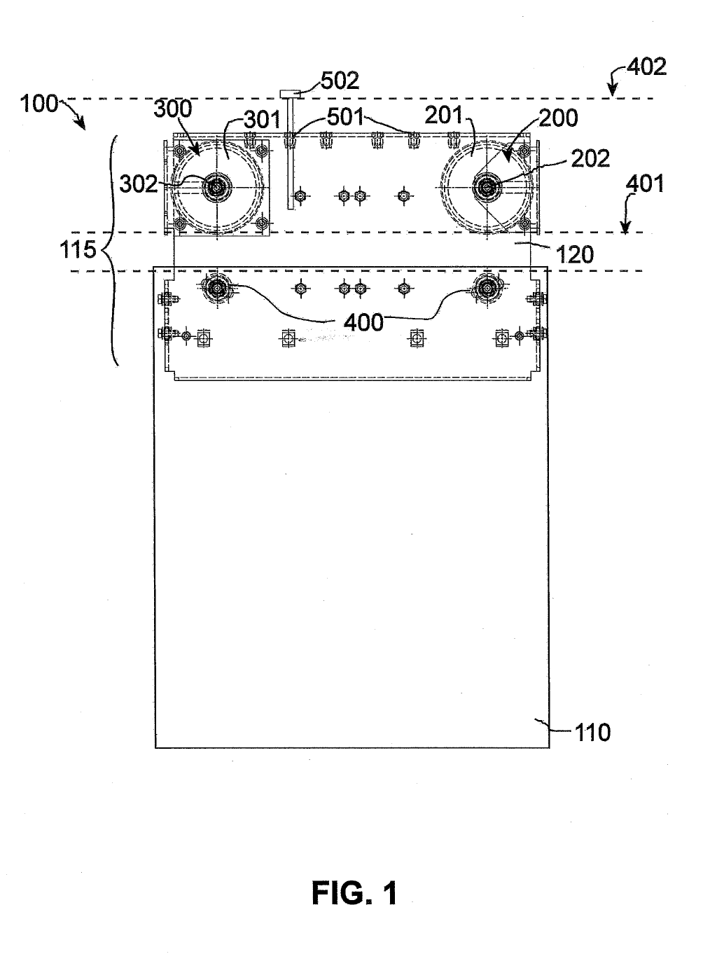

FIG. 1 shows, schematically, a lift door according to one embodiment of the invention, in a plan view of the principal plane of extent of the lift door, wherein the lift door as a whole is labelled 100. The lift door can in particular be a shaft door, wherein in this case the storey of the building would be behind the plane of the drawing and the lift shaft would be in front of the plane of the drawing. For an installer exchanging a running roller, this figure is thus a front view (according to the installer-related viewpoint chosen here; from the viewpoint of a passenger in the storey, it would be a rear view). The installer could for example stand on the roof of a car and look towards the door. For the sake of completeness, it is noted that it can also be a front view of a car door, as seen by the installer from the storey (from the viewpoint of a passenger in the car, it would be a rear view).

The lift door 100 has a door leaf 110, which is attached to a bearing unit 115. The bearing unit 115 has a supporting unit 120 and, in order to better represent possible embodiments of the invention, two—in this case different—running roller arrangements 200 and 300. In practice, a bearing unit commonly, but not necessarily, has identical running roller arrangements. The running roller arrangements have running rollers 201, 301 which mount the lift door 100 displaceably on a rail 401 of a door transom, whose upper edge is indicated by 402, in that the running rollers 201, 301 roll on the rail 401. The running rollers 201, 301 are mounted rotatably on bearing axles 202, 302. The running rollers 201, 301 support the weight of the lift door 100.

The bearing unit 115 further has two rotatably mounted counter rollers 400 which are arranged on the supporting unit 120 below the rail 401. The counter rollers 400 support no weight. They prevent the supporting unit 120 from accidentally separating from the rail 401. It can be recognized that the counter rollers 400 are not part of one of the running roller arrangements 200 and 300.

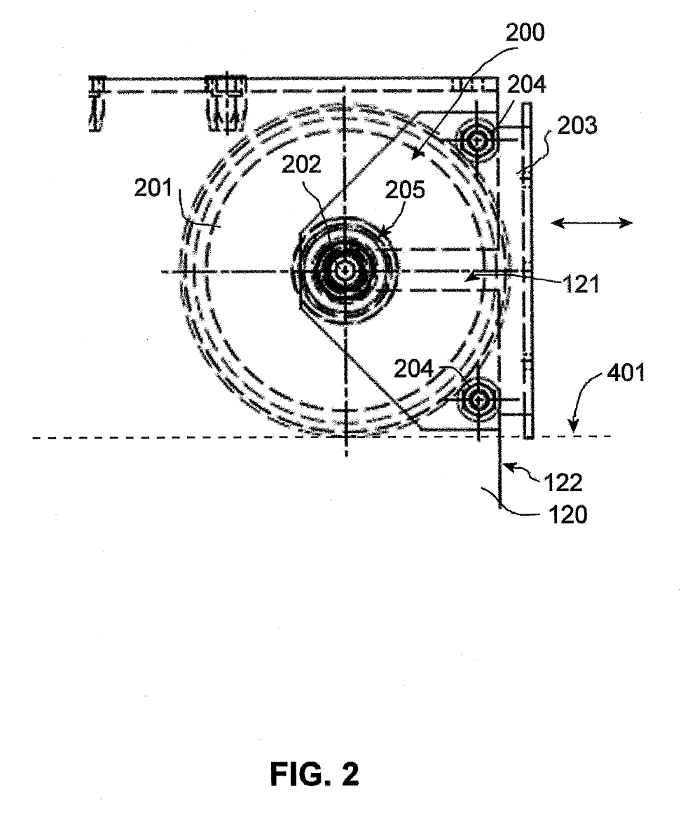

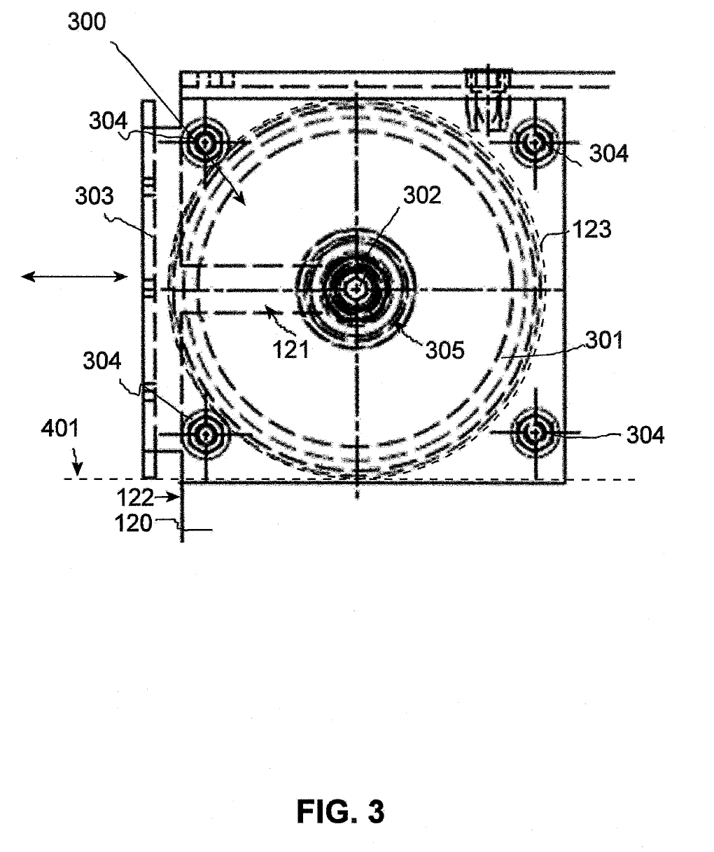

FIG. 2 shows, in more detail, the running roller arrangement 200 installed on the supporting unit 120; FIG. 3 shows, in more detail, the running roller unit 300 installed on the supporting unit 120. Elements from FIG. 3 which correspond to elements from FIG. 2 are provided with reference signs raised by 100 and will not be explained separately.

The running roller arrangement 200 has the running roller 201 and a bearing axle 202, to which the running roller 201 is rotatably mounted. The running roller arrangement 200 further has a retaining element 203, to which the bearing axle 202 is attached. The retaining element 203 has an axle opening 205 which serves for attaching the bearing axle 202. The supporting unit 120 too has an axle opening 121 which is designed to receive the bearing axle 202.

In the present example, the axle opening 121 is designed as a recess which opens towards an outer edge 122 of the supporting unit 120, in this case as a slot. The supporting unit is thus designed such that the running roller arrangement 200, 300 can be removed from the supporting unit in a direction (indicated by a double arrow) parallel to the principal plane of extent of the lift door.

In the embodiment represented in FIG. 2, the supporting unit has a horizontal axle opening 121, in order to improve the take-up of weight by the supporting unit, since the weight can be taken up by a massive region of the supporting unit 120 above the axle opening 121 and bearing axle 202. Nonetheless, a vertical (open towards the upper or lower edge) or oblique axle opening can also be provided.

The running roller arrangement 200 further has two connection openings 204 which serve for connecting the running roller arrangement 200 to the supporting unit 120 in particular via a screw connection, which can in particular comprise a thread in the supporting unit 120 and a screw inserted through the connection opening 204.

In order to remove the running roller arrangement 200, the screw connections in 204 are released and then the running roller arrangement 200 in FIG. 2 is removed from the supporting unit 120 towards the right. It can be provided that the bearing axle 202 also has to be loosened slightly if it is connected to the supporting unit 120 in a rotationally fixed manner when in the installed state.

Further exemplary embodiments will now be explained with reference to the running roller arrangement 300. The running roller arrangement 300 differs from the running roller arrangement 200 first in that four connection openings 304 are provided, for establishing a screw connection with the supporting unit. Accordingly, four threads are also provided in the supporting unit. It is to be noted that the number of connection openings and, accordingly, of threads, can be chosen freely.

The axle opening in the supporting unit 120, provided for the purpose of receiving the bearing axle 302, can again in this case be a horizontal (or also vertical or oblique) slot 121 or a recess of any shape, opening towards an outer edge. The axle opening can be dimensioned such that the bearing axle 302 can be attached therein in a force-fitting manner. The axle opening can also be dimensioned larger than the diameter of the bearing axle 302, such that in this case the weight would be supported only by the four screw connections in 304. In this case, the running roller arrangement 300 is removed towards the side.

The axle opening in the supporting unit 120, provided for the purpose of receiving the bearing axle 302, can alternatively also be designed to be large enough (e.g. as a round hole 123) that the running roller fits through it, such that the running roller arrangement 300 can be removed towards the front once the four screw connections in 304 have been released.

In order to permit a simple running roller change, at least one relief device 501 is provided in the lift door, in this case in the supporting unit 120, which relief device is designed to relieve a running roller arrangement. In the present example, a relief device 501 is provided for each of the running roller arrangements 200 and 300. The relief device is in this case designed as a screw device, wherein in the supporting unit 120 there is provided a nut or a tapped hole 501 which is designed to receive a screw 502.

According to one preferred embodiment, a support element, in this case a support opening, is present on the door transom above the tapped hole 501, e.g. on the upper edge 402, and supports the screw 502 on the door transom. If the screw 502 is screwed into the tapped hole 501, the screw 502—in this case the head thereof—is supported by the support element on the door transom, such that screwing-in of the screw pulls the supporting unit 120 upwards and thus lifts it off the rail and relieves the associated running roller arrangement.

According to an alternative embodiment, a support element, e.g. a rail attachment or the rail 401 itself, is present on the door transom below the tapped hole 501, which support element supports the screw 502 on the door transom. If the screw 502 is screwed into the tapped hole 501, the screw 502 abuts, after a certain travel, against the support element, e.g. the rail attachment or the rail 401 itself, such that further screwing-in of the screw lifts the supporting unit 120 off the rail at this point and thus relieves the associated running roller arrangement.

It can be necessary to loosen the counter roller 400 located beneath the rail 401 and to displace it downwards in the diagonal slot indicated in FIG. 1, in order to achieve sufficient space for raising the supporting unit 120.

In the relieved state, the running roller arrangement can easily be removed, in that the screw connections in 204, 304 are opened and, where relevant, the bearing axle 202, 302 is loosened, if this has a rotationally-fixed connection with the supporting unit 120 when in the installed state. The running roller arrangement can then be removed towards the side (i.e. in a direction parallel to the principal plane of extent of the door, that is to say not only right or left in FIG. 1 but also upwards, downwards or diagonally) or towards the front (i.e. in a direction perpendicular to the principal plane of extent of the door). Installation is effected mutatis mutandis.

1.-19. (canceled)

20. A lift door, comprising:
a door leaf;
a bearing unit coupled to the door leaf and configured to displaceably mount the lift door in a door transom, said bearing unit having
a supporting unit,
at least one running roller assembly coupled to said supporting unit, said roller assembly having at least a running roller configured to roll on a rail of the door transom and a bearig axle on which said running roller is rotatably mounted, said running roller assembly configured to be installed on and removed from said supporting unit as a single unit.

21. The lift door of claim 20, wherein said at least one running roller assembly includes only rollers that support a weight of said lift door.

22. The lift door of claim 21, wherein said at least one running roller assembly includes only said running roller, as the only roller.

23. The lift door of claim 21, wherein said at least one running roller assembly consists of said running roller and said bearing axle.

24. The lift door of claim 20, wherein said at least one running roller assembly further includes a retaining element coupled to said bearing axle.

25. The lift door of claim 20, wherein said running roller assembly is configured to be removable from said supporting unit in a direction parallel to a principal plane of extent of said lift door.

26. The lift door of claim 20, wherein said running roller assembly is configured to be removable from said supporting unit in a frontal direction with respect to said lift door.

27. The lift door of claim 20, wherein said supporting unit defines an axle opening disposed therein that is configured to receive said bearing axle therein.

28. The lift door of claim 27, wherein said axle opening in said supporting unit is at least one of a round hole, a slot, or a recess opening onto an outer edge of said supporting unit.

29. The lift door of claim 20, further comprising a relief device actuatably coupled to said supporting unit and configured to relieve said running roller assembly from the rail of the door transom, when said relief device is actuated.

30. The lift door of claim 29, wherein said relief device is a screw device configured to lift said running roller off the rail of the door transom, when said bearing unit is in the door transom.

31. The lift door of claim 29, wherein said relief device includes at least one of a nut or tapped hole and a screw.

32. A lift door assembly, comprising:
a lift door according to claim 29; and
a door transom having a rail and further having a support opening defined therein that is configured to support said relief device of said lift door when said relief device is actuated, wherein said lift door is displaceably mounted in said door transom, and wherein said running roller of said running roller assembly of said lift door rests on said rail of said door transom,

33. A method for installing or removing a running roller from a supporting unit of a lift door, comprising:
providing a lift door as described in claim 1; and
at least one of installing or removing the lift door's running roller while the running roller is structurally connected to the bearing axle that supports the running roller.

34. The method of claim 33, wherein said at least one of installing or removing steps is performed in a direction parallel to a principal plane of an extent of the lift door.

35. The method of claim 33, further comprising at least one of installing or removing the lift door's running roller respectively towards or from a front of the lift door.

36. A method for installing or removing a running roller from a supporting unit of a lift door, comprising:
providing a lift door assembly as described in claim 32;
actuating the relief device of the lift door assembly so as to ensure the running roller assembly will be disengaged from the rail of the door transom upon either of installation or removal of the lift door's running roller; and
at least one of installing or removing the lift door's running roller while the running roller is structurally connected to the bearing axle that supports the running roller.

37. The method of claim 36, wherein said step of actuating the relief device lifts the running roller assembly off the rail of the transom.

38. The method of claim 37, wherein said step of actuating the relief device either pulls the running roller assembly towards the support element or pushes the running roller assembly away from the support element.
